(19) United States
(12) Patent Application Publication
(10) Pub. No.: US 2020/0173802 A1
(43) Pub. Date: Jun. 4, 2020

(54) ROUTE PARAMETER MANAGER SYSTEM

(71) Applicant: Cummins Inc., Columbus, IN (US)

(72) Inventors: Arun Prakash Thunga Gopal, Columbus, IN (US); Vivek Anand Sujan, Columbus, IN (US); Kenneth M. Follen, Greenwood, IN (US); Howard Robert Frost, Columbus, IN (US); Jaidev Khatri, Rochester Hills, MI (US); Pinak Jayant Tulpule, Columbus, IN (US); Apurva Arvind Chunodkar, Greenwood, IN (US); Mugdha S. Sane, Columbus, IN (US); Yared G. Tadesse, Indianapolis, IN (US); Tejas Shrikant Kinjawadekar, Pune (IN); Archit N. Koti, Columbus, IN (US); Xuan Feng, Columbus, IN (US); Patrick J. Shook, Franklin, IN (US); Feng Liu, Columbus, IN (US)

(21) Appl. No.: 16/637,954

(22) PCT Filed: Aug. 7, 2018
(86) PCT No.: PCT/US18/45581

§ 371 Date: Feb. 10, 2020

Related U.S. Application Data
(60) Provisional application No. 62/544,242, filed on Aug. 11, 2017.

(51) Int. Cl. G01C 21/34; G01C 21/30

(52) U.S. Cl. CPC G01C 21/3492; G01C 21/30; G01C 21/3484

(57) ABSTRACT

Systems and apparatuses include a vehicle locator circuit that is structured to receive GPS signal coordinates and a road parameter associated with the GPS signal coordinates. The vehicle locator circuit is further structured to identify a current road segment associated with the GPS coordinates. A map data circuit is structured to store the road parameter and GPS signal coordinates associated with the current road segment. A route response circuit is structured to determine look-ahead parameters characterizing a future road segment based on input received from the vehicle locator circuit and the map data circuit, and a communication interface is structured to communicate the look-ahead parameters to an engine control module for improving vehicle performance during travel on the future road segment.

### RELATED APPLICATIONS

This application claims priority to and the benefit of U.S. Provisional Patent Application No. 62/544,242, filed Aug. 11, 2017, entitled “ROUTE PARAMETER MANAGER SYSTEM”, which is incorporated herein by reference in its entirety.

### TECHNICAL FIELD

The present disclosure relates to advanced driver assistance systems. More particularly, the present disclosure relates to systems and methods for operating a route parameter manager and improving vehicle operating parameters.

### BACKGROUND

A typical route parameter manager (RPM) for a vehicle is a device that contains a digital map database. The RPM provides information about the upcoming road, known as route electronic horizon, and includes road attributes like speed limits, grade, curvature, fuel stations, road type, etc. Electronic horizon data is sent to a receiving controller (e.g., a Cycle Efficiency Manager (CEM)). Systems which make use of this electronic horizon data to improve vehicle performance (e.g., fuel efficiency) are called Advanced Driver Assistance Systems (ADAS). The CEM uses the route electronic horizon data to command engine and vehicle operation to improve fuel economy.

### SUMMARY

One embodiment relates to an apparatus that includes a vehicle locator circuit that is structured to receive GPS signal coordinates and a road parameter associated with the GPS signal coordinates. The vehicle locator circuit is further structured to identify a current road segment associated with the GPS coordinates. A map data circuit is structured to store the road parameter and GPS signal coordinates associated with the current road segment. A route response circuit is structured to determine look-ahead parameters characterizing a future road segment based on input received from the vehicle locator circuit and the map data circuit, and a communication interface is structured to communicate the look-ahead parameters to an engine control module for improving vehicle performance during travel on the future road segment.

These and other features, together with the organization and manner of operation thereof, will become apparent from the following detailed description when taken in conjunction with the accompanying drawings.

### BRIEF DESCRIPTION OF THE FIGURES

FIG. 1 is a perspective view of a vehicle on a roadway according to one embodiment;

FIG. 2 is a schematic representation of the vehicle of FIG. 1 according to one embodiment;

FIG. 3 is a schematic representation of a controller of the vehicle of FIG. 1 according to one embodiment;

FIG. 4 is a flow diagram representing a method of creating a learned route map according to one embodiment

FIG. 5 is a flow diagram representing a method of using the learned route map created in FIG. 4;

FIG. 6 is a schematic representation of inputs and outputs of the controller of FIG. 3 according to one embodiment;

FIG. 7 is a schematic representation of a process of the controller of FIG. 3 according to one embodiment;

FIG. 8 is a schematic representation of a vehicle locator circuit of the controller of FIG. 3 according to one embodiment;

FIG. 9 is a schematic representation of a map data circuit of the controller of FIG. 3 according to one embodiment;

FIG. 10 is a schematic representation of a method of determining vehicle location according to one embodiment;

FIG. 11 is another schematic representation of a method of determining vehicle location according to one embodiment;

FIG. 12 is another schematic representation of a method of determining vehicle location according to one embodiment;

FIG. 13 is a schematic representation of a method of determining a start of a route condition according to one embodiment;

FIG. 14 is a schematic representation of a method of setting distance travelled indicator flags according to one embodiment;

FIG. 15 is a schematic representation of a method of determining a look-ahead window according to one embodiment;

FIG. 16 is a perspective view of a fleet of vehicles travelling along a road according to one embodiment;

FIG. 17 is a schematic representation of a surrogate sensing control method according to one embodiment;

FIG. 18 is a perspective view of a fleet of vehicles communicating using a vehicle-to-vehicle system according to one embodiment;

FIG. 19 is a perspective view of a fleet of vehicles communicating using a server system according to one embodiment;

FIG. 20 is a flow diagram of a method for operating a vehicle in view of learned route map information according to one embodiment;

FIG. 21 is a schematic representation of input factors used by the method of FIG. 20 according to one embodiment;

FIG. 22 is a schematic representation of factors affecting uncertainty in the method of FIG. 20 according to one embodiment;

FIG. 23 is a flow diagram of a method of fusing acquired route data according to one embodiment;

FIG. 24 is a graphical representation of determined changes in a road parameter of a learned route map according to one embodiment;

FIG. 25 is a schematic representation of a RPM that can be used in an off-highway application according to one embodiment;

FIG. 26 is a flow diagram of a method of creating a route map using the RPM system of FIG. 25 according to one embodiment; and

FIG. 27 is a flow diagram of a method of using the route map created using the method of FIG. 26 according to one embodiment.

### DETAILED DESCRIPTION

Following below are more detailed descriptions of various concepts related to, and implementations of, methods, apparatuses, and systems for route parameter manager and route learning systems. The various concepts introduced above and discussed in greater detail below may be implemented in any number of ways, as the concepts described are not limited to any particular manner of implementation. Examples of specific implementations and applications are provided primarily for illustrative purposes.

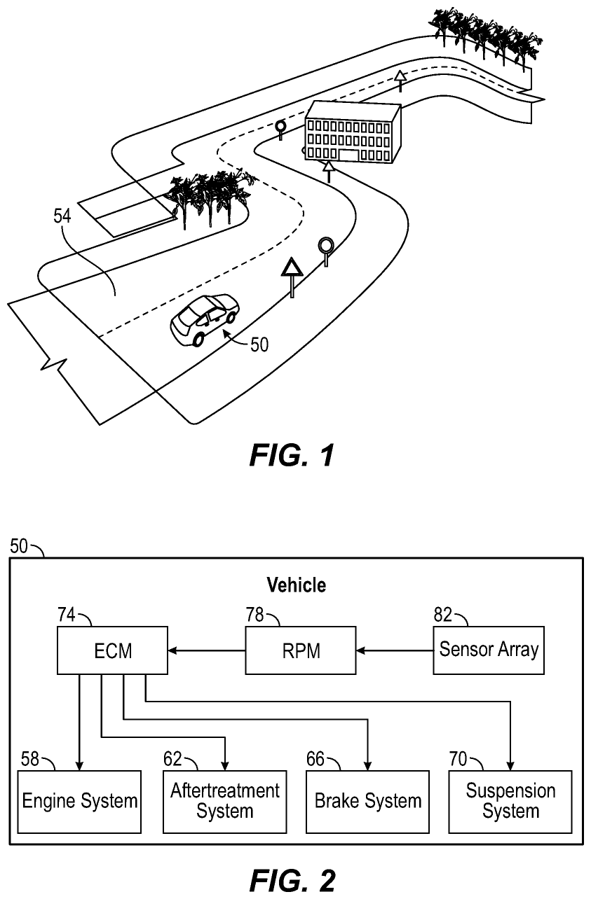

Referring to the figures generally and in a particular example, FIG. 1, the various embodiments disclosed herein relate to systems, apparatuses, and methods for a vehicle 50 that includes look-ahead sensors and a route parameter manager (RPM) structured to identify the location of the vehicle 50 on a roadway 54 and predict a future roadway or route parameter. The RPM can be used to predict future road parameters (e.g., pitch or grade, radius of curvature, speed limit, fuel stations, road type, etc.), instruct a driver of beneficial behavior, or provide other information to either an engine control unit (ECU), the driver, or another vehicle system to improve vehicle performance (e.g., fuel efficiency, engine loading, suspension loading, braking activations, etc.). In some embodiments, the vehicle 50 learns the road parameters during repeated trips along a specified route and uses the learned road parameters in future trips along the specified route. In some embodiments, the vehicle 50 communicates with a server or other remote controller to determine road parameters learned by other vehicles. In some embodiments, the vehicle 50 communicates directly with other vehicles that have learned road parameters. In some embodiments, the learned road parameters can be sent from the vehicle 50 to another vehicle, or to a server so that the learned road parameters can be used by other vehicles.

As shown in FIG. 2, the vehicle 50 includes an engine system 58, an aftertreatment system 62, a braking system 66, and a suspension system 70. In some embodiments, the engine system 58 includes a fuel system with actuators that can control an amount of fuel injected into combustion chambers and the timing of injection, and an air handling system with actuators that can control an amount of air provided to the combustion chambers and the timing of air injection. In some embodiments, the engine system 58 includes a compression ignition engine (e.g., a diesel engine) or a spark ignition engine (e.g., a gasoline engine). In some embodiments, the engine system 58 includes an electric motor and controllers structured to control the electric motors or other electric machines to propel the vehicle 50.

The aftertreatment system 62 is structured to accept exhaust gases from the engine system 58 and to treat the exhaust gases before return to the engine system 58 or expulsion from the vehicle 50. In some embodiments, the aftertreatment system 62 includes a three way catalytic converter. In some embodiments, the aftertreatment system 62 includes exhaust gas recirculation (EGR), a particulate filter, a diesel exhaust fluid (DEF) dosing system, a selective catalytic reduction (SCR) catalyst, and/or other components.

The brake system 66 includes brake actuators structured to slow the vehicle 50. In some embodiments, the brake system 66 includes a regenerative braking system, disc brakes, drum brakes, and/or another braking system.

The suspension system 70 supports the vehicle 50 and can include actuators and adjustable suspension components that may be controlled in response to learned road parameters.

The engine system 58, the aftertreatment system 62, the brake system 66, and the suspension system 70 are controlled by an electronic control module (ECM) 74. In some embodiments, the ECM 74 may include multiple control modules structured to control individual systems of the vehicle 50. In some embodiments, the ECM 74 adjusts operating parameters of the engine system 58 to improve performance (e.g., fuel efficiency, power, etc.) in response to learned road parameters. In some embodiments, the ECM 74 adjusts operating parameters of the aftertreatment system 62 to improve performance (e.g., fuel efficiency, power, etc.). In some embodiments, the ECM 74 adjusts operating parameters of the braking system 66, the suspension system 70, and/or other vehicle systems to improve performance (e.g., fuel efficiency, stability, energy conservation, etc.).

A route parameter manager (RPM) 78 provides instructions to the ECM 74 about the upcoming road. This information is known as route look-ahead data or electronic Horizon and includes road attributes or parameters like speed limits, grade, curvature, fuel stations, road type, etc. In some embodiments, the RPM 78 includes a cycle efficiency manager (CEM) and/or an advanced driver assistance system (ADAS). A CEM is a system structured to optimize fuel economy over the drive cycle by using physics based algorithms that help to optimize vehicle speed, manage acceleration and available power, and intelligently make powertrain control decisions. The CEM can use improved knowledge of current and upcoming learned road parameters to improve powertrain control.

A sensor array 82 provides data to the RPM 78 and can include GPS transmitters and receivers, speed sensors, altimeters, grade sensors or inclinometers, tachometers, accelerometers, gyroscopes, compasses, and other sensors as desired. The sensor array 82 communicates with the RPM 78 to provide location data and other data useful in determining road parameters both for initial route learning and for tracking the progress of the vehicle 50 along a learned route.

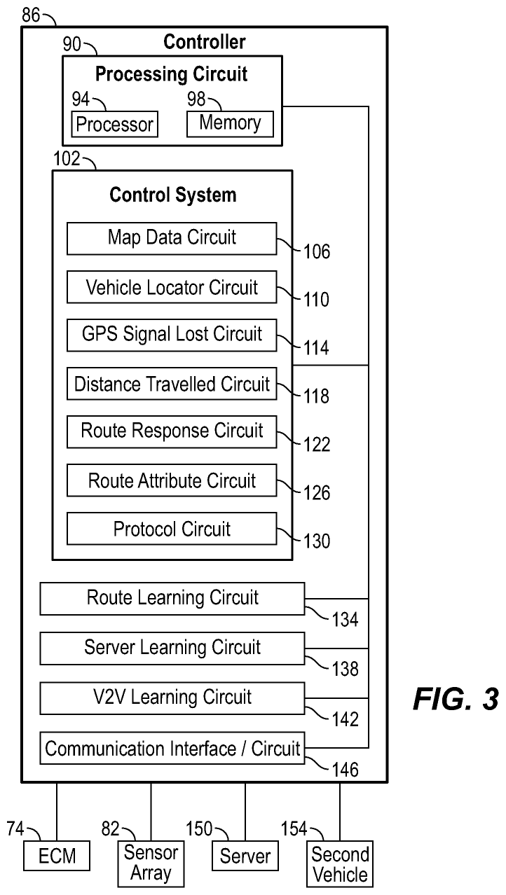

As the components of FIG. 2 are shown to be embodied in the vehicle 50, the RPM 78 and ECU 74 can generally be referred to as a controller 86 that may be structured as one or more electronic control units (ECU) and one or more RPM units. The controller 86 may be separate from or included with at least one of a transmission control unit, an exhaust aftertreatment control unit, a powertrain control module, an engine control module, etc. The function and structure of the controller 86 is described in greater detail in FIG. 3.

Referring now to FIG. 3, a schematic diagram of the controller 86 of the vehicle 50 of FIG. 1 is shown according to an example embodiment. As shown in FIG. 3, the controller 86 includes a processing circuit 90 having a processor 94 and a memory device 98; a control system 102 having a map data circuit 106, a vehicle locator circuit 110, a GPS signal lost circuit 114, a distance travelled circuit 118, a route response circuit 122, a route attribute circuit 126, and a protocol circuit 130; a route learning circuit 134; a server learning circuit 138; a vehicle-to-vehicle (V2V) learning circuit 142; and a communications interface 146. Generally, the controller 86 is structured to learn or create a route map or receive a route map learned by another vehicle (e.g., via a server communication or direct V2V communication), determine the vehicle's 50 location on the route map, and utilize learned route attributes to improve performance of the vehicle 50 along the route map.

In one configuration, the map data circuit 106, the vehicle locator circuit 110, the GPS signal lost circuit 114, the distance travelled circuit 118, the route response circuit 122, the route attribute circuit 126, the protocol circuit 130, the route learning circuit 134, the server learning circuit 138, and the vehicle-to-vehicle (V2V) learning circuit 142 are embodied as machine or computer-readable media that is executable by a processor, such as processor 94. As described herein and amongst other uses, the machine-readable media facilitates performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). The computer readable media may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, the map data circuit 106, the vehicle locator circuit 110, the GPS signal lost circuit 114, the distance travelled circuit 118, the route response circuit 122, the route attribute circuit 126, the protocol circuit 130, the route learning circuit 134, the server learning circuit 138, and the vehicle-to-vehicle (V2V) learning circuit 142 are embodied as hardware units, such as electronic control units. As such, the map data circuit 106, the vehicle locator circuit 110, the GPS signal lost circuit 114, the distance travelled circuit 118, the route response circuit 122, the route attribute circuit 126, the protocol circuit 130, the route learning circuit 134, the server learning circuit 138, and the vehicle-to-vehicle (V2V) learning circuit 142 may be embodied as one or more circuitry components including, but not limited to, processing circuitry, network interfaces, peripheral devices, input devices, output devices, sensors, etc. In some embodiments, the map data circuit 106, the vehicle locator circuit 110, the GPS signal lost circuit 114, the distance travelled circuit 118, the route response circuit 122, the route attribute circuit 126, the protocol circuit 130, the route learning circuit 134, the server learning circuit 138, and the vehicle-to-vehicle (V2V) learning circuit 142 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the map data circuit 106, the vehicle locator circuit 110, the GPS signal lost circuit 114, the distance travelled circuit 118, the route response circuit 122, the route attribute circuit 126, the protocol circuit 130, the route learning circuit 134, the server learning circuit 138, and the vehicle-to-vehicle (V2V) learning circuit 142 may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on). The map data circuit 106, the vehicle locator circuit 110, the GPS signal lost circuit 114, the distance travelled circuit 118, the route response circuit 122, the route attribute circuit 126, the protocol circuit 130, the route learning circuit 134, the server learning circuit 138, and the vehicle-to-vehicle (V2V) learning circuit 142 may also include programmable hardware devices such as field programmable gate arrays, programmable array logic, programmable logic devices or the like. The map data circuit 106, the vehicle locator circuit 110, the GPS signal lost circuit 114, the distance travelled circuit 118, the route response circuit 122, the route attribute circuit 126, the protocol circuit 130, the route learning circuit 134, the server learning circuit 138, and the vehicle-to-vehicle (V2V) learning circuit 142 may include one or more memory devices for storing instructions that are executable by the processor(s) of the map data circuit 106, the vehicle locator circuit 110, the GPS signal lost circuit 114, the distance travelled circuit 118, the route response circuit 122, the route attribute circuit 126, the protocol circuit 130, the route learning circuit 134, the server learning circuit 138, and the vehicle-to-vehicle (V2V) learning circuit 142. The one or more memory devices and processor(s) may have the same definition as provided below with respect to the memory device 98 and processor 94. In some hardware unit configurations, the map data circuit 106, the vehicle locator circuit 110, the GPS signal lost circuit 114, the distance travelled circuit 118, the route response circuit 122, the route attribute circuit 126, the protocol circuit 130, the route learning circuit 134, the server learning circuit 138, and the vehicle-to-vehicle (V2V) learning circuit 142 may be geographically dispersed throughout separate locations in the vehicle 50. Alternatively, and as shown, the map data circuit 106, the vehicle locator circuit 110, the GPS signal lost circuit 114, the distance travelled circuit 118, the route response circuit 122, the route attribute circuit 126, the protocol circuit 130, the route learning circuit 134, the server learning circuit 138, and the vehicle-to-vehicle (V2V) learning circuit 142 may be embodied in or within a single unit/housing, which is shown as the controller 86.

In the example shown, the controller 86 includes a processing circuit 90 having a processor 94 and a memory 98. The processing circuit 90 may be structured or configured to execute or implement the instructions, commands, and/or control processes described herein with respect to the map data circuit 106, the vehicle locator circuit 110, the GPS signal lost circuit 114, the distance travelled circuit 118, the route response circuit 122, the route attribute circuit 126, the protocol circuit 130, the route learning circuit 134, the server learning circuit 138, and the vehicle-to-vehicle (V2V) learning circuit 142. The depicted configuration represents the map data circuit 106, the vehicle locator circuit 110, the GPS signal lost circuit 114, the distance travelled circuit 118, the route response circuit 122, the route attribute circuit 126, the protocol circuit 130, the route learning circuit 134, the server learning circuit 138, and the vehicle-to-vehicle (V2V) learning circuit 142 as machine or computer-readable media. However, as mentioned above, this illustration is not meant to be limiting as the present disclosure contemplates other embodiments where the map data circuit 106, the vehicle locator circuit 110, the GPS signal lost circuit 114, the distance travelled circuit 118, the route response circuit 122, the route attribute circuit 126, the protocol circuit 130, the route learning circuit 134, the server learning circuit 138, and the vehicle-to-vehicle (V2V) learning circuit 142, or at least one circuit of the map data circuit 106, the vehicle locator circuit 110, the GPS signal lost circuit 114, the distance travelled circuit 118, the route response circuit 122, the route attribute circuit 126, the protocol circuit 130, the route learning circuit 134, the server learning circuit 138, and the vehicle-to-vehicle (V2V) learning circuit 142, is configured as a hardware unit. All such combinations and variations are intended to fall within the scope of the present disclosure.

The processor 94 may be implemented as one or more general-purpose processors, an application specific integrated circuit (ASIC), one or more field programmable gate arrays (FPGAs), a digital signal processor (DSP), a group of processing components, or other suitable electronic processing components. In some embodiments, the one or more processors may be shared by multiple circuits (e.g., the map data circuit 106, the vehicle locator circuit 110, the GPS signal lost circuit 114, the distance travelled circuit 118, the route response circuit 122, the route attribute circuit 126, the protocol circuit 130, the route learning circuit 134, the server learning circuit 138, and the vehicle-to-vehicle (V2V) learning circuit 142 may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure. The memory 98 (e.g., RAM, ROM, Flash Memory, hard disk storage, etc.) may store data and/or computer code for facilitating the various processes described herein. The memory 98 may be communicably connected to the processor 94 to provide computer code or instructions to the processor 94 for executing at least some of the processes described herein. Moreover, the memory 98 may be or include tangible, non-transient volatile memory or non-volatile memory. Accordingly, the memory 98 may include database components, object code components, script components, or any other type of information structure for supporting the various activities and information structures described herein.

In the following discussion, a travelled route refers to a roadway, path, or other route driven by the vehicle 50, a learned route refers to a previous travelled route, a link refers to a section of a learned route, a point refers to a special location along a link, and a resolution refers to a spacing between points.

The map data circuit 106 is structured in communication with the vehicle locator circuit 110 and the distance travelled circuit 118 and provides map data or road parameters (e.g., grade, speed limit, etc.) for a given position on a learned route. The map data circuit 106 is also structured in communication with the memory 98 and accesses saved information and road parameters regarding the learned route that are stored in the memory 98. In some embodiments, the map data circuit 106 defines links and nodes along the learned route. In some embodiments, each link has road parameters that change along the link as an offset from a link start increases. In some embodiments, the road parameters on a given link are assumed constant.

The vehicle locator circuit 110 is in communication with the sensor array 82 and receives a GPS coordinate (e.g., latitude and longitude) of the vehicle 50. The vehicle locator circuit 110 is also in communication with the map data circuit 106 and receives road parameters and information regarding the learned route. In some embodiments, the vehicle locator circuit 110 also receives other information from the sensor array 82 (e.g., yaw rate, speed, compass direction, grade, altitude, etc.). In some embodiments, the vehicle locator circuit 110 identifies the location of the vehicle 50 on a link by identifying the link in coordination with the map data circuit 106 and by determining a link offset.

The GPS signal lost circuit 114 is structured to determine when the vehicle location circuit 110 is no longer receiving a GPS signal. In some embodiments, a GPS signal loss is determined by checking update rates of the GPS message received through the communication interface 146. If a new GPS signal is not received within a certain time interval or predetermined time limit (e.g., five times the normal refresh rate), a signal loss condition is set. In some embodiments, if the GPS signal lost circuit 114 determines that the GPS signal is lost, then the GPS signal lost circuit 114 indicates that the map data is no longer valid and communicates to the ECM 74 via the communication interface 146 that the RPM 78 should no longer dictate operating parameters of the vehicle 50. In some embodiments, the GPS signal loss is communicated as a part of a roadway status message to the ECM 74.

The distance travelled circuit 118 is structured to create distance travelled indicator (DTI) flags every time the vehicle 50 travels a set or predetermined distance. The DTI flag communicated to the ECM 74 as part of the roadway status message to create common knowledge of the vehicle 50 position. In some embodiments, a new DTI flag is set every fifty meters (50 m). In some embodiments, a new DTI flag is set more than every fifty meters or less than every fifty meters. In some embodiments, the roadway status message is transmitted to the ECM 74 about every five seconds (5 s). In some embodiments, the roadway status message is transmitted to the ECM 74 no faster than about every one-hundred milliseconds (100 ms), or when a change occurs.

The route response circuit 122 is structured to produce a route request message at predetermined intervals (e.g., time or distance), and receives input from the vehicle locator circuit 110. The route request message includes a look-ahead start distance, a requested resolution, and a requested number of points. The look-ahead start distance defines a distance in front of the vehicle 50 that the route response circuit 122 will analyze the learned route (e.g., fifty meters). In some embodiments, the look-ahead start distance and upcoming link lengths are used to determine a link number corresponding to the first point in the route request message. The resolution and number of points are used to determine how far ahead the RPM 78 analyzes. The route response circuit 122 outputs a link number corresponding to each of the links that includes identified look-ahead points. In some embodiments, the attributes of each link are assumed to be constant and the link numbers are sufficient to identify the attribute data (e.g., speed limits, grade, etc.).

The route attribute circuit 126 is structured to receive the link numbers from the route response circuit 122 and identify or extract road attributes associated with the link numbers. In some examples, the route attribute circuit 126 extracts a road grade data and a speed limit data associated with each link number.

The protocol circuit 130 is structured to receive the extracted road parameters from the route attribute circuit 126 and to provide the extracted road parameters to the ECM 74 via the communications interface 146. In some embodiments, the protocol circuit 130 receives the route request message from the ECM 74 and provides the route request message to the route response circuit 122. In some embodiments, the protocol circuit 130 sends a status message such as the roadway status message discussed above with respect to the GPS signal loss circuit 114, a parameter configuration message, and a roadway information response message to the ECM 74. The parameter configuration message can include road parameters (e.g, speed limits, grade, etc.) and provides the flexibility to customize a setup to transmit parameters of interest thereby reducing overhead by not requiring transmission of all available data. It also serves as a handshake message or confirmation of connection between the RPM 78 and ECM 74 at startup or when recovering from a fault. The roadway information response message can include look-ahead data at the requested resolution and location and can be setup to use Transport Layer Protocol when the number of points requested does not fit in one CAN frame.

The route learning circuit 134 is structured in communication with the control system 102 and communicates with the sensor array 82 via the communications interface 146. The route learning circuit 134 is structured to log data points and correlate the data to GPS locations over a travelled route as the vehicle 50 drives. In some embodiments, the route learning circuit 134 is structured to receive a start learning command and log location associated data over a travelled route so that the location associated data can be used by the map data circuit 106 to create a learned route map.

The server learning circuit 138 is structured in communication with the control system 102 and communicates with a server 150 via the communications interface 146. The server 150 can include learned route map data acquired by other vehicles in a fleet of vehicles, or the vehicle 50 driving a travelled route and creating the learned route map. The server learning circuit 138 is structured to receive learned route map data from the server 150 and to provide the learned route map to the map data circuit 106. The server learning circuit 138 is also structured to log data points and correlate the data to GPS locations over a travelled route as the vehicle 50 drives. The server learning circuit 138 is structured to receive a start learning command and log location associated data over a travelled route so that the location associated data can be used by the map data circuit 106 to create a learned route map, and to upload the learned route map to the server 150.

The vehicle-to-vehicle (V2V) learning circuit 142 is structured in communication with the control system 102 and communicates with a second vehicle 154 via the communications interface 146. The second vehicle 154 can include learned route map data acquired on a previously travelled route. The V2V learning circuit 142 is structured to receive learned route map data from the second vehicle 154 and to provide the learned route map to the map data circuit 106. The V2V learning circuit 142 is also structured to log data points and correlate the data to GPS locations over a travelled route as the vehicle 50 drives. The V2V learning circuit 142 is structured to receive a start learning command, and log location associated data over a travelled route so that the location associated data can be used by the map data circuit 106 to create a learned route map, and to communicate the learned route map to the second vehicle 154.

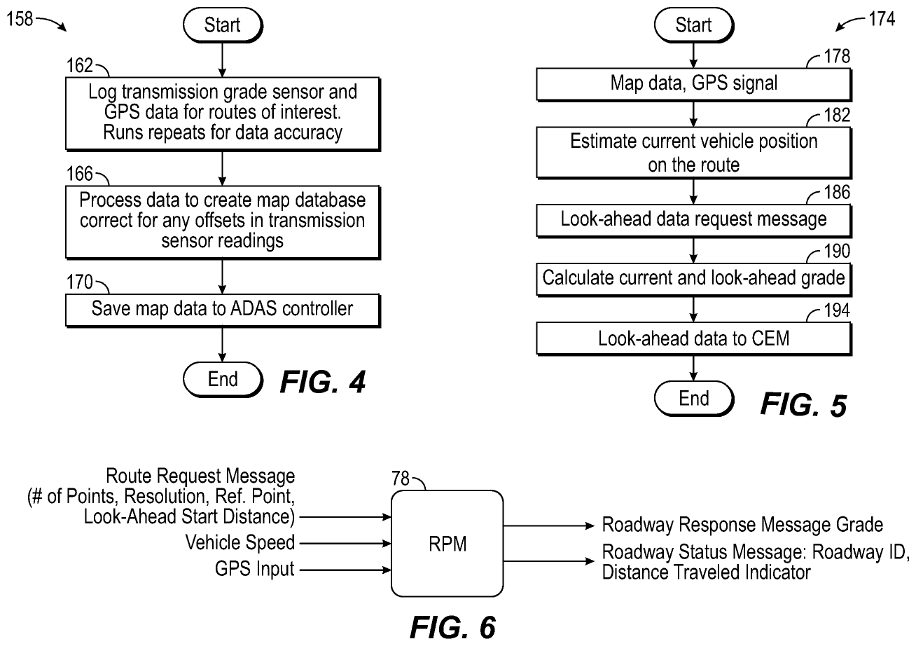

As shown in FIG. 4, a method 158 of creating a learned route map includes logging data with the route learning circuit 134 as the vehicle 50 drives along the travelled route at step 162. Step 162 can be completed multiple times while creating a learned route map, and the learned route map can be updated on subsequent trips along the learned route after the learned route map has been created.

At step 166, the map data circuit 106 processes the data that was logged in step 162 and creates the learned route map. The map data circuit 106 can also correct for any inconsistencies or offsets that exist in the received data from the sensor array 82. In some embodiments, the created map includes links, and each link includes defined road parameters (e.g., grade, speed limit, etc.). At step 170, the learned route map is saved to the map data circuit 106 or the memory 98. Once the learned route map is saved, it can be accessed in the future when the vehicle 50 drives along the learned route.

As shown in FIG. 5, a method 174 of using the learned route map during subsequent drives along the learned route includes accessing the learned route map stored by the map data circuit 106 and the GPS signal from the sensor array 82 at step 178. At step 182, the vehicle locator circuit 110 uses the information gathered in step 178 and estimates the current vehicle position. In some embodiments, estimating the vehicle position includes identifying a link that the vehicle 50 is on and an offset within the identified link.

At step 186, the route request message is produced by the route response circuit 122. The route request message can include the look-ahead start distance, the resolution, and the number of points. The route response circuit 122 also produces the link number and offset values and sends them to the route attribute circuit 126.

At step 190, the route attribute circuit 126 extracts the road parameters associated with the link currently occupied by the vehicle 50 as identified by vehicle locator circuit 110, and the road parameters of the look-ahead links identified by the route response circuit 122. The current and look-ahead road parameters are provided to the protocol circuit 130 and then sent to the ECM 74 via the communications interface 146 at step 194 so that the ECM 74 can control the vehicle 50 in response to the road parameters.

As shown in FIG. 6, the RPM 78 generally receives inputs from the sensor array 82, the ECM 74, and other circuits within the controller 86. In some embodiments, the RPM 78 receives the route request message, the vehicle speed, and the GPS coordinates of the vehicle 50, and outputs a roadway response message including grade and speed limit data for both the current location and the look-ahead start distance. In some embodiments, the RPM 78 also outputs a roadway status message that can include a roadway identification and a DTI. The roadway status message can be used by the ECM 74 to determine if the roadway response message should be used by the ECM 74. For example, if the roadway status message indicates that the vehicle 74 is no longer on the learned route, then the ECM 74 can ignore or not use the roadway response message.

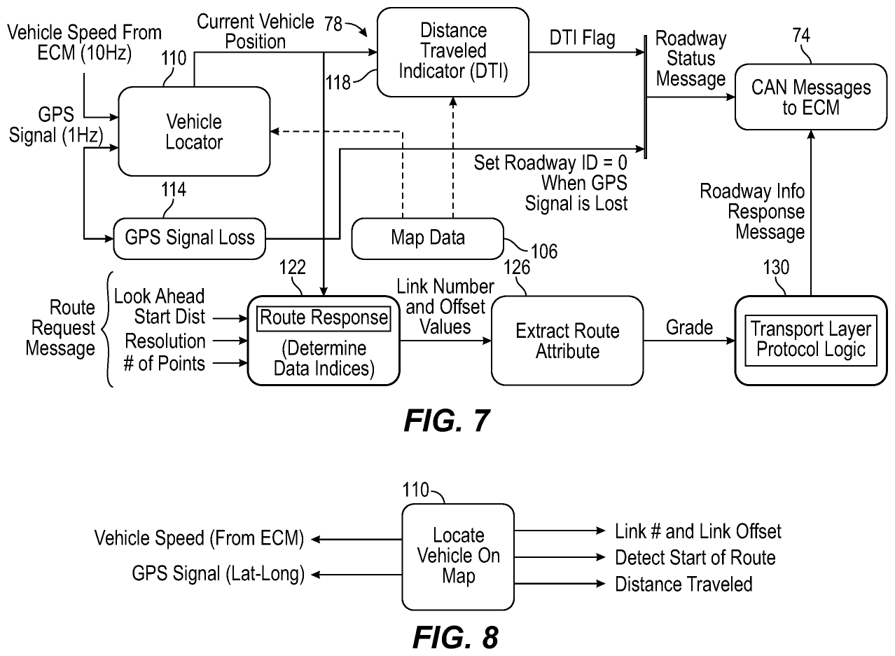

FIG. 7 shows an exemplary architecture of the RPM 78. The map data circuit 106 provides information to the vehicle location circuit 110 and the distance travelled indicator circuit 118. The vehicle locator circuit 106 uses the information from the map data circuit 106 and information received from the sensor array 82, including GPS coordinates and vehicle speed, to determine the position of the vehicle 50 and identify the link and link offset of the vehicle 50 on the learned route map. The current vehicle position including link information is provided to the distance travelled indicator circuit 118 and to the route response circuit 122. The GPS signal loss circuit 114 communicates a status message including a lost GPS signal. In some embodiments, the lost GPS signal can be provided to the distance travelled indicator circuit 118. Together, the GPS signal loss circuit 114 and the distance travelled indicator circuit 118 provide the roadway status message to the ECM 74.

The route response circuit 122 receives the current vehicle location information from the vehicle locator circuit 110, and additionally receives the route request message from the ECM 74. The route request message can include the look-ahead start distance, the resolution, and the number of points. In some embodiments, fourteen points are used by the RPM 78 for the look-ahead data. The route response circuit 122 identifies link numbers and offset values associated with the look-ahead range. The route attribute circuit 126 receives the identified link numbers and offset values from the route response circuit 122 and extracts the road parameters associated with the identified links and offsets from the learned route map (e.g., from the map data circuit 106).

The extracted road parameters are sent from the route attributes circuit 126 to the protocol circuit 130 where the road parameters are packaged (e.g., using a CAN protocol) and sent to the ECM 74. The ECM 74 can then use the extracted road parameters to manipulate various system actuators and powertrain systems to improve vehicle 50 performance (e.g. fuel economy).

As shown in FIG. 8, the vehicle locator circuit 110 is structured to receive a vehicle speed input from either the ECM 74 or the sensor array 82 independent of the ECM 74. The vehicle speed input can include a compass direction or be direction independent. The vehicle locator circuit 110 also receives a GPS signal input in the form of latitude and longitude coordinates from a GPS receiver that is part of the ECM 74 or the sensor array 82. The vehicle locator circuit 110 uses the received data along with information retrieved from the map data circuit 106 to determine where the vehicle 50 is located along the learned route. Once the vehicle locator circuit 110 determines the vehicle's 50 location along the learned route, the link number is output. Additionally, the vehicle locator circuit 110 recognizes or detects when the vehicle 50 starts, begins, or enters a learned route. In some embodiments, the vehicle locator circuit 110 can determine a distance travelled by the vehicle 50 along the learned route.

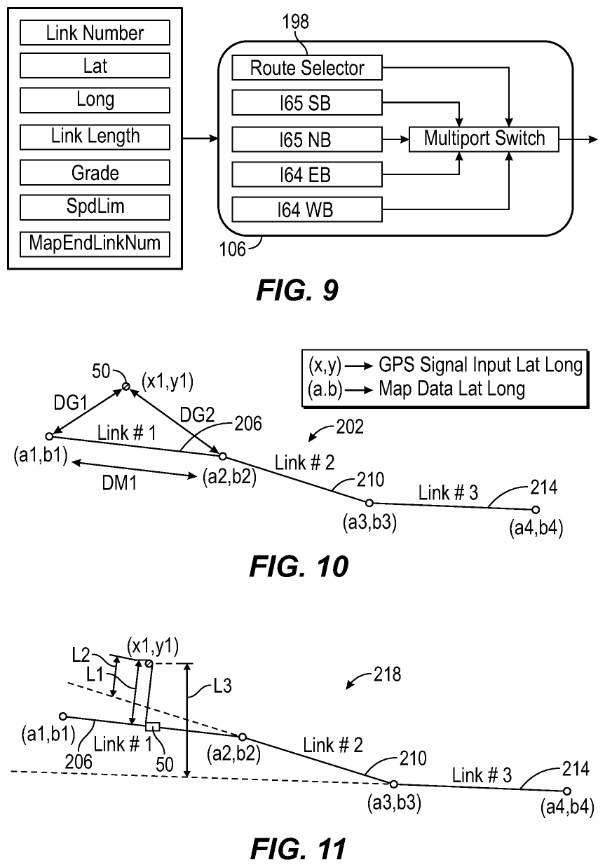

As shown in FIG. 9, the map data circuit 106 is structured to store or access a plurality of learned route maps (e.g., 165 SB, 165 NB, 165 EB, and 165 WB) and to receive route data from the route learning circuit 134, the server learning circuit 138, and/or the V2V learning circuit 142 during map creation, updating, or verification operations. In some embodiments, route data includes latitude and longitude coordinates, link numbers, link lengths, speed limit and grade vectors, and a map end link number. When the vehicle link number (e.g., the current location of the vehicle 50 on the learned route) is equal to the map end link number, an on-route flag is set to zero, the RPM 78 stops requesting data and the route ends. In some embodiments, a learned route can be selected using a route selector 198 that may include a user interface structured to receive user input dictating the learned route map for the RPM 78 to use.

As shown in FIG. 10, a method 202 of locating the vehicle 50 on the learned route map includes identifying GPS signal coordinates (x1,y1) and map data coordinates (a,b), a first link 206, a second link 210, and a third link 214. In some embodiments, more than three links are included in the learned route map. For example, some learned route maps may include hundreds of links. The difference between the current GPS signal coordinates (x1,y1) and a first map coordinate (a1,b1) of the first link 206 is a start offset DG1, and the difference between the current GPS signal coordinates (x1,y1) and a second map coordinate (a2,b2) of the first link 210 is an end offset DG2. In some embodiments, the start offset DG1 is defined as:

DG1=\sqrt{(x1−a1)²+(y1−b1)²}

In some embodiments, DG2 is defined as:

DG2=\sqrt{(x1−a2)²+(y1−b2)²}

In some embodiments, a distance between the first map coordinate (a1,b1) and the second map coordinate (a2,b2) is defined as:

DM1=\sqrt{(a1−a2)²+(b1−b2)²}

In some embodiments, a link length DM1 is defined on a line between the first map coordinate (a1,b1) and the second map coordinate (a2,b2).

Method 202 considers the current GPS signal coordinates (x1,y1) to map the first link 206 if the following equation is satisfied:

max(DG1,DG2)<=DM1

For simplification and as distances between consecutive points are small, in some embodiments it is assumed that latitude and longitude are Cartesian coordinates. If the end offset DG2=0 then (x1,y1) coincides with (a2,b2) and the vehicle locator circuit 110 determines that the vehicle 50 is now located on the second link 210.

As shown in FIG. 11, a method 218 of locating the vehicle 50 on the learned route map includes determining a first perpendicular distance L1 from the first link 206, a second perpendicular distance L2 from the second link 210, and a third perpendicular distance L3 from the third link 214. The link which the GPS signal coordinate (x1,y1) will be mapped to is the one with the shortest perpendicular distance and with the projection of the GPS signal coordinate (x1,y1) lying between the end points of the link (e.g., (a1,b1) and (a2,b2) for the first link 206).

As shown in FIG. 12, at any given time, the position of the vehicle 50 is defined by a link number and an offset from a start of the link. A GPS input signal is used to position the vehicle 50 on a link with a link number and an offset from the start of the link. A vehicle speed integrator is used in between two consecutive GPS inputs to keep track of the vehicle's 50 position. The vehicle speed integrator is corrected using the GPS signal coordinates every time a new GPS ping is received. The vehicle speed integrator is reset to zero at the end of a link and the current link number is incremented by one. In the example shown in FIG. 12, as the vehicle 50 begins travelling along a first link 222 and leaves the point (aᵢ₋₁bᵢ₋₁) the vehicle speed integrator is used to estimate the position of the vehicle 50 along the first link 222. When the GPS signal coordinate (xⱼ,yⱼ) is received, the vehicle locator circuit 210 corrects the position of the vehicle 50 along the first link 222. When the vehicle locator circuit 210 estimates that the vehicle 50 has entered a second link 226 (e.g., by receipt of GPS signal coordinates, by vehicle speed integrator based estimation, etc.), then the link offset value is reset to zero. Again, on the second link 226 the vehicle speed integrator is used to estimate the position of the vehicle 50 on the second link 226 and the position is corrected when GPS signal coordinates (xⱼ₊₁,yⱼ₊₁) are received.

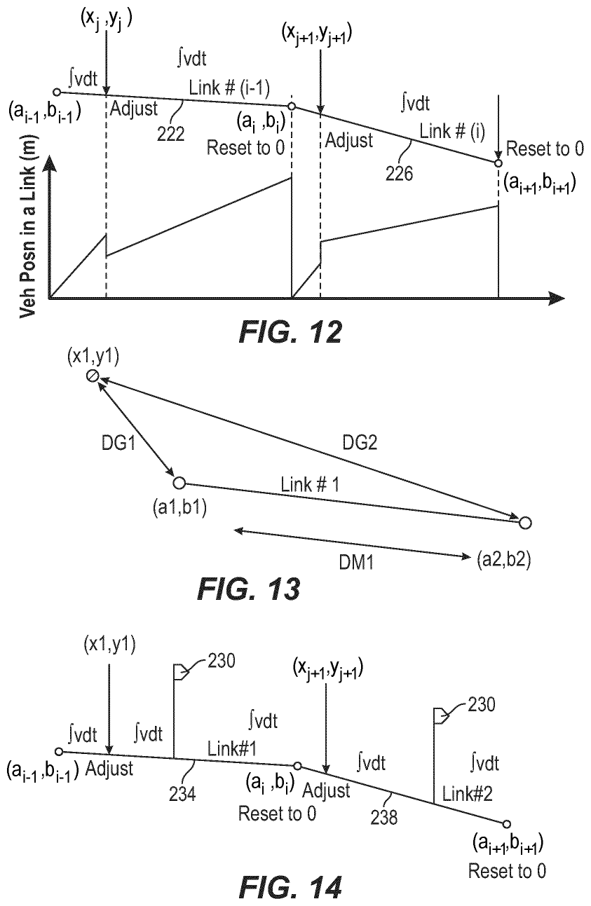

As shown in FIG. 13, a start of a learned route can be detected by comparing distances between the vehicle 50 and nodes between links of a learned route map. For example, in an initial condition, when the vehicle 50 is approaching a learned route, if either the start offset DG1 or the end offset DG2 are larger than the link length DM1, and the end offset DG2 is larger than the start offset DG1, then the vehicle 50 has not yet reached the learned route. Once this condition becomes false, then the vehicle locator circuit 210 indicates that the vehicle 50 has reached the start of the learned route. In normal operation, the first link in the map data will be used to detect start of route. However, if the test is aborted, or if the vehicle 50 joins a learned route at a point other than the start, then a mid-learned route start point can selected by determining GPS signal coordinates of current position of the vehicle 50 and the heading of the vehicle 50. The vehicle locator circuit 210 can then pick the next upcoming link number from the learned route map. Using mid-learned route start points can avoid the need to drive back to the start of the route for testing.

As shown in FIG. 14, the distance travelled circuit 118 creates DTI flags 230 every time the vehicle 50 travels a set or predetermined distance. Each DTI flag 230 is part of the route status message and can be used to sync the position of the vehicle 50 in the RPM 78. The predetermined distance can be determined using the link number, the link offset, and the vehicle speed integrator to estimate distance traveled. In some embodiments, the estimation is completed within the distance travelled circuit 118 or in the vehicle locator circuit 110. In some embodiments, every time the vehicle 50 travels fifty meters (50 m), the DTI flag 230 is set. The distance travelled circuit 118 stores the position of this last DTI flag 230 (e.g., the link number and the link offset), and if the distance traveled from last DTI flag 230 is negative (e.g., when the next GPS signal coordinates locate the vehicle 50 behind the position calculated by vehicle speed integrator) the distance travelled circuit 118 assigns a new link offset as the last DTI flag 230 and resets the distance from the last DTI flag 230 to zero. While travelling along a first link 234, the next DTI flag 230 is placed according to the following equation:

current link offset−offset of last DTI flag=50 m

If the vehicle 50 moves to a second link 238, the next DTI flag 230 is placed according to the following equation:

(Previous link length−offset of last flag)+current link offset=50 m

In some embodiments, the DTI flag 230 is set with a spacing of more than fifty meters or less than fifty meters (e.g., twenty-five meters, seventy-five meters, one-hundred-twenty-five meters, etc.). In some embodiments, the distance travelled circuit 118 uses fourteen DTI flags 230 at any given time and assignment of DTI flags 230 is cyclical. In some embodiments, the roadway status message is transmitted about every five seconds or on change, but no faster than 100 ms.

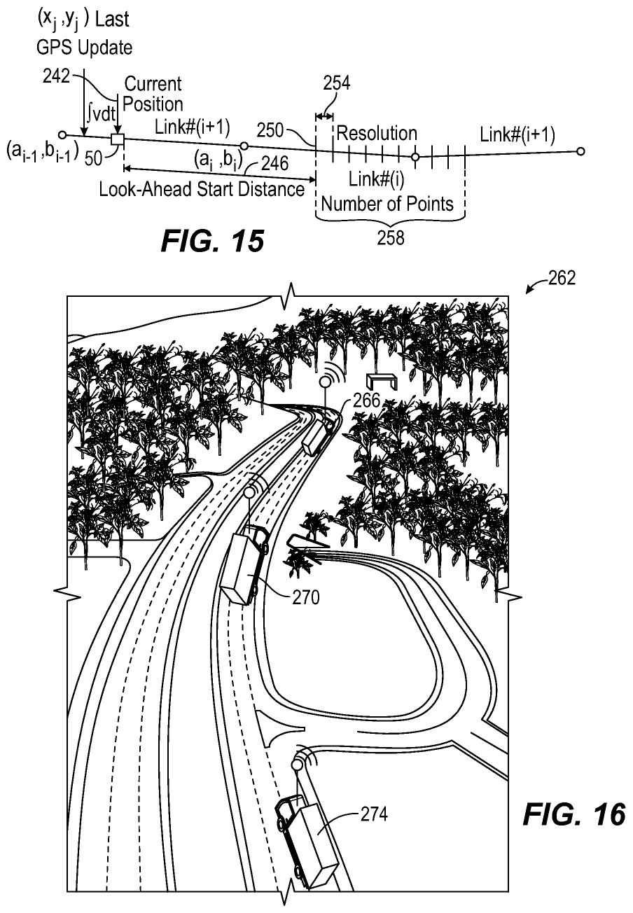

As shown in FIG. 15, when the route response circuit 122 receives the route request message, the current position 242 of the vehicle 50 is used as the point of reference. The look-ahead start distance 246 and upcoming link lengths are used to determine the link number corresponding to the first point 250 in the requested look-ahead data. The resolution 254 and number of points 258 are used to then locate the remaining look-ahead points on the associated links. The output of the route response circuit 122 is a link number corresponding to each of the look-ahead points. In some embodiments, the link attributes are constant within each individual link and the link numbers are sufficient to read the road parameter data (e.g., speed limits and grade).

As shown in FIG. 16, the server learning circuit 138 or the V2V learning circuit 142 can be used to provide a surrogate sensing control method. Surrogate sensing control can be useful when a fleet of vehicles 262 is operated. Generally, in the methods discussed above, the vehicle 50 must drive along the travelled route while running learning routines and creating the learned route map. On subsequent drives along the learned route, the vehicle 50 can take advantage of the learned route map. However, in the fleet of vehicles 262, a lead vehicle 266 can learn or create the learned route map and share the learned route map with the server 150, and/or a second vehicle 270, a third vehicle 274, and other vehicles as desired. In some embodiments, any trailing vehicle (e.g., the third vehicle 274) receives information and learned route map data from all leading vehicles ahead (e.g., the lead vehicle 266 and the second vehicle 270). The trailing vehicle (e.g., the third vehicle 274) fuses or blends the information received with prior information to create a fused route profile (i.e., learned route map) of relevant road parameters based on all the information shared by the leading vehicles (e.g., the lead vehicle 266 and the second vehicle 270). Surrogate sensing control allows information to be shared between vehicles so that complete maps (including off route areas) are not required. The surrogate sensing control provides the route data required by other vehicles.

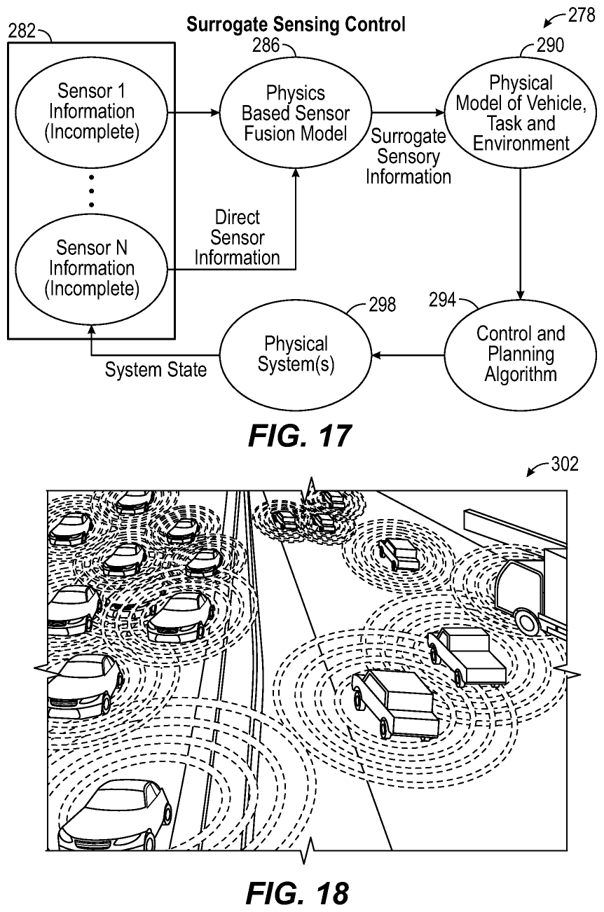

As shown in FIG. 17, a method 278 includes receiving learned route map data from leading vehicles at step 282. Additionally at step 282, the learned route map data is transmitted by the trailing vehicle (e.g., the third vehicle 274) to the server 150 or to other vehicles. At step 286, the received learned route map data is fused with sensor data from the trailing vehicle and a fused route profile is created at step 290. In some embodiments, the fused route profile includes links and road parameters similar to those discussed above. At step 294, the fused route profile is communicated to the ECM 74 and control systems are actuated to improve vehicle performance. At step 298, the control systems enact the instructions of the ECM 74 and feedback is then provided and recognized by the sensor array 82 at step 282. The method 278 allows for dynamic learning of a route as a fleet of vehicles travels the route. In other words, the system is capable of real time learning.

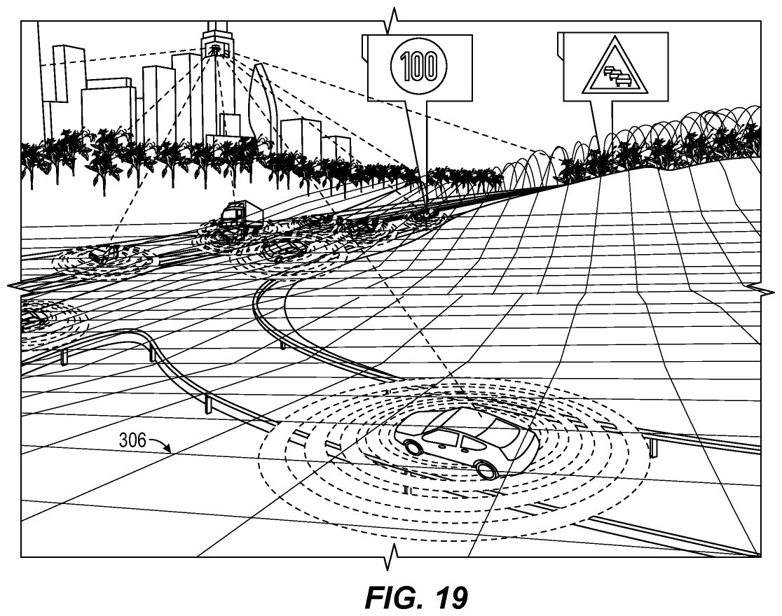

As shown in FIG. 18, a fleet of vehicles 302 is structured to communicate directly via each individual vehicle's V2V learning circuit 142. As shown in FIG. 19, a fleet of vehicles 306 is structured to communicate with the server 150 via each individual server learning circuit 138 so that learned route map data may be shared over long distances or be processed, at least in part, by a remote computer. In some embodiments, a combination of V2V communication and server communication is used to create and use the learned route map or the fused route profile.

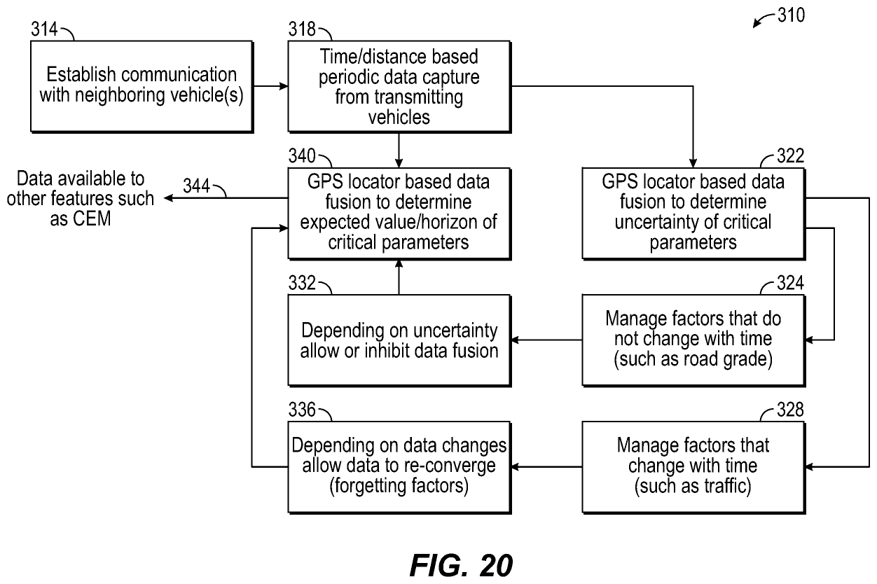

As shown in FIG. 20, a method 310 of surrogate sensing control includes establishing a V2V connection or a server connection at step 314 by the target vehicle. Once a connection is established, at step 318 periodic data captures are collected from connected vehicles and/or the server 150. At step 322, GPS data is used to determine a spacing between lead vehicles and other factors can be used to determine an uncertainty of the road parameters. At step 324, the RPM 78 of the target vehicle identifies factors that do not change (e.g., road grade), and at step 328 factors that do change are identified (e.g., traffic patterns and effects, weather conditions). At step 332, non-changing factors are used by the RPM 78 if the uncertainty is below a threshold value. At step 336, changing factors are used by the RPM 78 if the uncertainty is below a threshold value. At step 340, a data fusion algorithm combines available data and creates a fused route profile. At step 344, the fused route profile is communicated to and used by the CEM 74 to improve vehicle performance.

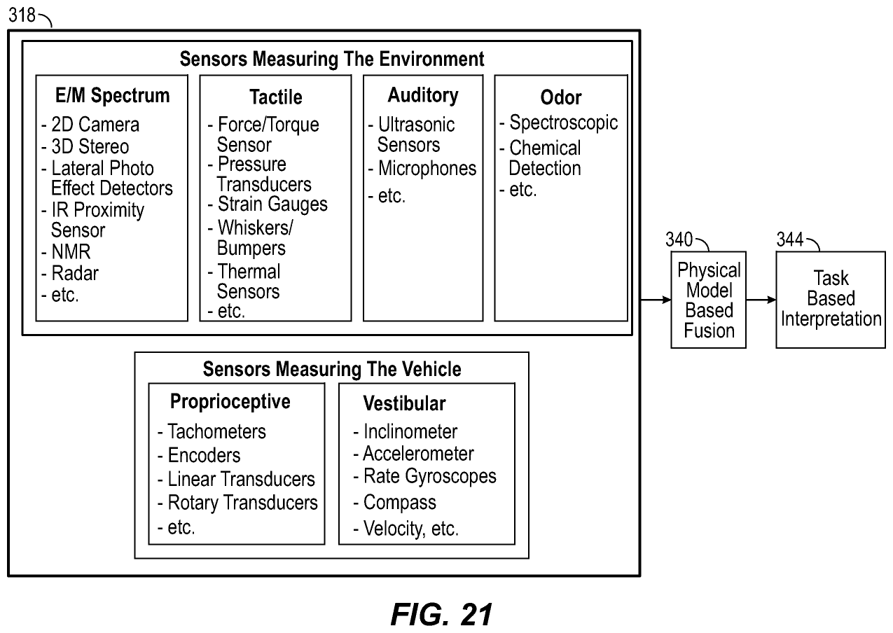

As shown in FIG. 21, the data collected at step 318 can include a variety of environmental and/or vehicle specific factors. In some embodiments, more factors or less factors may be utilized. The relevant and selected factors are combined in a fusion model at step 340 and provided to the ECM 74 at step 344. The data fusion or sensor fusion falls into the larger category of sensory data uncertainty management and integrates the new data streams with the older/redundant data sets to create and augment a learned route map or a fused route profile of the relevant parameters.

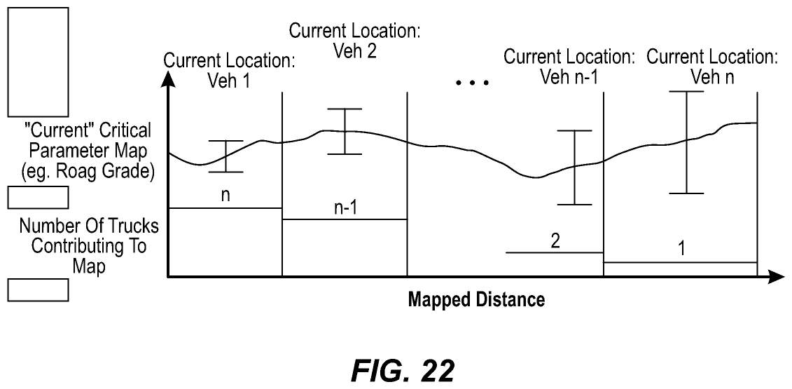

As shown in FIG. 22, data fusion is based on real time data streaming from leading vehicles. Uncertainty will increase the larger the distance is between the target vehicle and the lead vehicles, and uncertainty will increase when there are fewer lead vehicles. Statistically, uncertainty increases with distance from the source data.

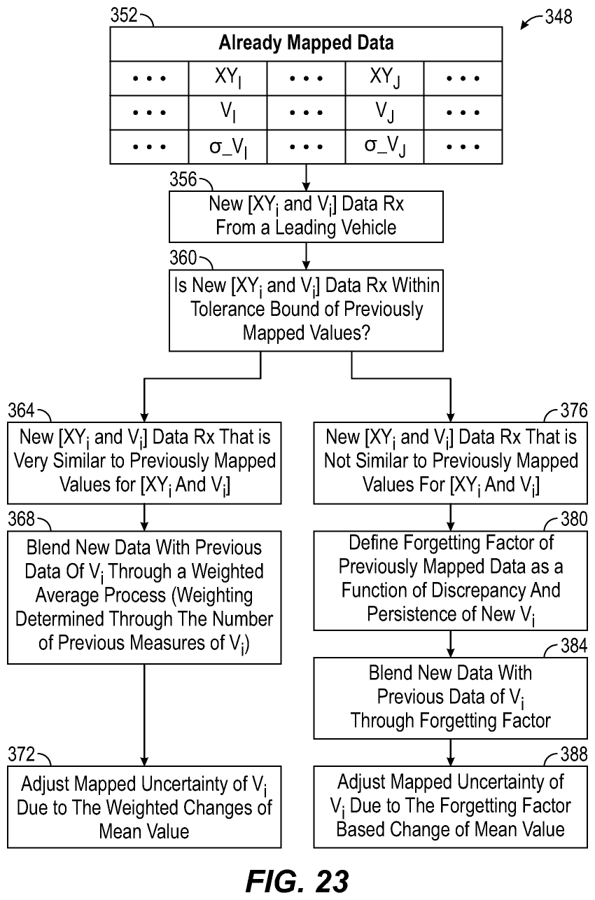

As shown in FIG. 23, a method 348 of creating the fused route profile includes recognizing or accessing the stored fused route profile or the learned route map at step 352. At step 356, new data is received from leading vehicles or from the server 150. At step 360, the data received in step 356 is compared to the accessed data from step 352. If the RPM 78 determines at step 364 that the new data is substantially similar to the stored data, then the new data is blended with the stored data using a weighted average process at step 368. Once the fused route profile is updated, the updated road parameters (e.g., average actual speed, traffic, brake activity, etc.) can be used by the ECM 74 at step 372.

If the RPM 78 determines at step 376 that the new data is substantially different from the stored data, then a forgetting factor is defined. The forgetting factor may be a function of discrepancy with current measurements, and/or may be based on uncertainty. In some embodiments, uncertainty is based on both leading vehicle sensor error as well as a measure of the confidence in how much the parameter may change by the time the target vehicle reaches that point. At step 384, the new data is fused with the stored data taking into account the forgetting factor. For example, if only one of many leading vehicles indicates a change, the RPM 78 may ignore the new data. At step 388, the fused route profile is updated in view of the new data and the forgetting factor.

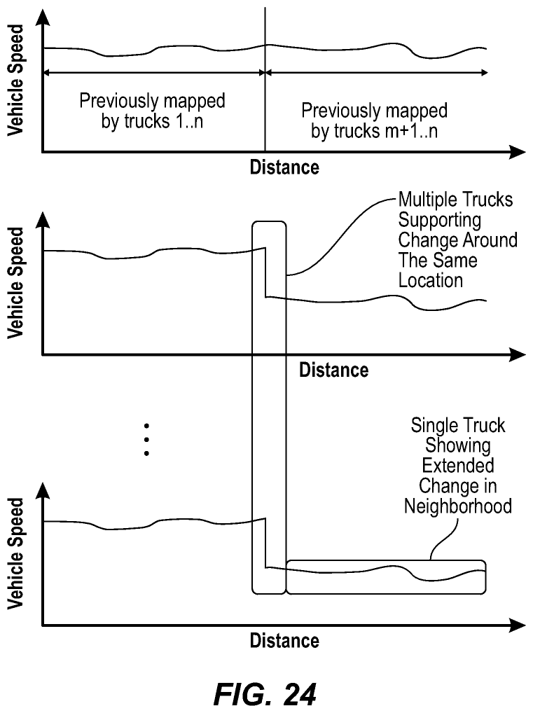

As shown in FIG. 24, defining the forgetting factor is defined as a function of persistence in change of a road parameter. Persistence of change may come in the form of multiple vehicles providing support (e.g., repetitive confirmation) to the change of the road parameter at or near the position of the target vehicle and/or a single vehicle showing an extended change to the road parameter in the area of the location of the target vehicle (this must be supported by multiple vehicles if there are multiple sources of incoming data). FIG. 24 shows vehicle speed as a function of distance. Truck 1 is closest to the reference Truck 0 and Truck n is furthest away. Truck 0 has previously mapped the section ahead based on data streaming from Trucks 1 . . . n. At some location, Truck m shows a reduction in vehicle speed indicating a significant change (eg. traffic related). Following this, trucks m−1 . . . 1 support this by indicating the same change as they pass the same location. Additionally, the trucks m . . . 1 show that the change continues over a future distance. Given this new data, the previous data from trucks m+1 . . . n in the region of the change (from which the region mapping had been done), is forgotten. The rate of forgetting may be a function of various factors such as the number of trucks reporting the change, the amount of change, and/or the existence of ongoing change with distance, etc.

In addition to the on road applications discussed above, the systems and methods described herein can have significant advantages when used in off-highway or off-road applications (e.g., off a paved road, in a mine, etc.). For example, mining operators desire solutions to improve mine haul truck performance metrics, while addressing emission requirements, reducing fuel consumption, improving productivity, and minimizing total cost of ownership. Utilizing historic and predictive information such as learned route maps provides the opportunity to self-optimize the mine dispatching systems, truck drive systems, engine systems, and the integration of these systems. In general, the above described approaches of individual vehicle route learning, server based route learning, and V2V route learning can be applied to off-highway applications. The resulting learned route maps can be used to improve ECM 74 operation, provide driver feedback and improve driver behavior, and inform operation of autonomous vehicles.

The cyclical or repetitive nature of routes provides an opportunity to collect several data sets to help learn the route topology and use it as a low cost look ahead system to reduce total cost of ownership. Such repetitive nature of routes also provides better insight into driver driving styles and a better opportunity to learn good driving characteristics and deploy them across a fleet. The RPM 78 allows the system to adapt to changes in route and route condition over time as routes in mining applications, even though repetitive, tend to change over time depending on various factors like mine expansion, weather conditions, etc. One strategy includes learning routes or staying in a learning mode until learned route map data has met a threshold fidelity.

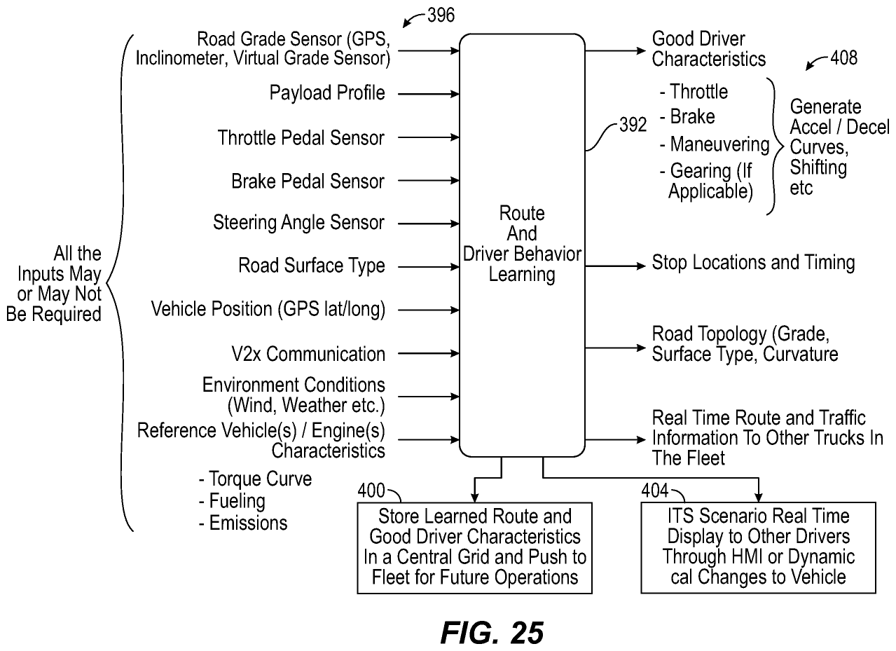

As shown in FIG. 25, an RPM 392 for an off-highway vehicle can receive inputs 396 including road grade, payload, throttle lever position, brake pedal position, steering angle, road surface type, vehicle position, V2V communication, server communication, environmental conditions, engine and other vehicle system feedback, and other inputs. In some embodiments, less than all these inputs are used.

At block 400, the RPM 392 can share recorded data with other vehicles (e.g., V2V) or with a server or central grid. The stored data can then be used by other vehicles and vehicle operators to improve driving performance. At block 404, information received from other vehicles and/or the server is provided to the vehicle and to the operator via ECM communication, or human machine interface (HMI) to enact driving and vehicle performance improvements.

Vehicle outputs 408 can be transmitted to other vehicles directly or to the server/central grid. Vehicle outputs 408 can include good driver characteristics, stop locations and timing (e.g., driving behavior), road topology, and/or route traffic information. In some embodiments, more or less outputs can be included.

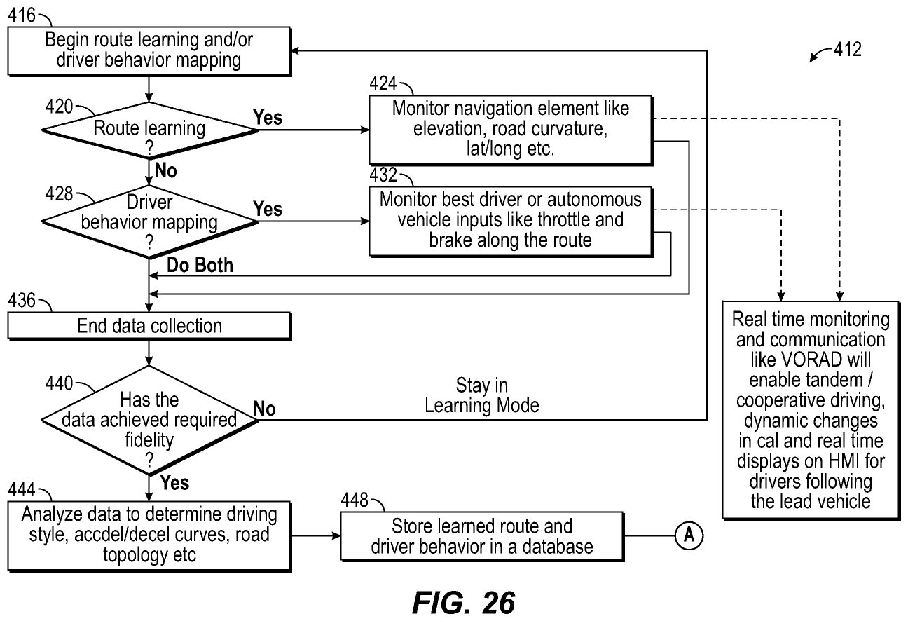

As shown in FIG. 26, a method 412 includes starting a learning routine at step 416. At step 420, the RPM 392 determines if route learning is desired or required. If the RPM 392 dictates that route learning should occur, then the RPM 392 receives inputs and associates the inputs to vehicle location to create mapped route parameters at step 424. If the RPM 392 does not dictate route learning at step 420, then the RPM 392 determines if driver behavior mapping is desired or required at step 428. If the RPM 392 dictates that driver behavior mapping should occur, then the RPM 392 receives inputs and associates the inputs to vehicle location to create mapped route parameters at step 432. Route learning at step 424 and driver behavior mapping at step 428 can occur simultaneously in some embodiments.

At step 436, data collection is stopped and data fidelity is checked at step 440. Fidelity of the data collected can be based on, say, convergence of standard deviation after ‘n’ runs. A threshold fidelity can be set at which the method 412 will end the learning mode.

At step 444, the RPM 392 analyzes the learned route and identifies beneficial driving behaviors and route dependent variables (e.g., road grade, turn curvature, etc.). At step 448, the route parameters are saved to a learned route map that can include links and associated route attributes or parameters. The learned route map can be shared directly with other vehicles (e.g., V2V) uploaded to a server, or used only by the vehicle for future runs. In some embodiments, the learned route can be updated during future learning modes using a weighted average, or a moving average that can adapt more quickly to changing topography.

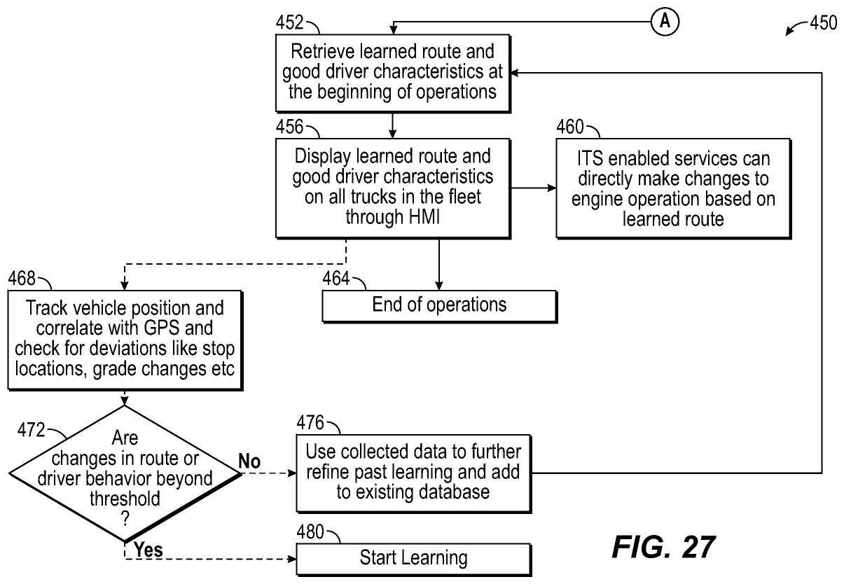

As shown in FIG. 27, a method 450 of using the learned route map created in the method 412 includes retrieving the road parameters of the learned route map with the RPM 392 at step 452, including information relevant to operation of the vehicle engine and to desirable driver behavior. At step 456, the good driving behaviors are displayed to the vehicle driver through an HMI or other interface device. At step 460, the RPM 392 communicates with the ECM of the vehicle to control engine and other vehicle system operation in view of the learned route map and road parameters associated with the vehicle's position and the look-ahead distance. At step 464, operations are ended if the vehicle exits the learned route or if the vehicle is turned off

If the vehicle continues operation, the method 450 moves on to step 468 and monitors the sensors and other system inputs as the vehicle operates along the learned route. If the RPM 392 determines that the inputs are different from the saved road parameters and other inputs associated with the learned route map, the RPM 392 compares the changes to a threshold value at step 472. If the changes do not exceed the threshold, the RPM 392 continues to use the learned route map and updates the values of the learned route map at step 476. If the RPM 392 determines at step 472 that the changes do exceed the threshold, then at step 480 the method 450 returns to the learning mode described in method 412.

No claim element herein is to be construed under the provisions of 35 U.S.C. § 112(f), unless the element is expressly recited using the phrase “means for.”

For the purpose of this disclosure, the term “coupled” means the joining or linking of two members directly or indirectly to one another. Such joining may be stationary or moveable in nature. For example, a propeller shaft of an engine “coupled” to a transmission represents a moveable coupling. Such joining may be achieved with the two members or the two members and any additional intermediate members. For example, circuit A communicably “coupled” to circuit B may signify that the circuit A communicates directly with circuit B (i.e., no intermediary) or communicates indirectly with circuit B (e.g., through one or more intermediaries).

While various circuits with particular functionality are shown in FIGS. 1-27, it should be understood that the controller 86 may include any number of circuits for completing the functions described herein. For example, the activities and functionalities of the circuits of the controller 86 may be combined in multiple circuits or as a single circuit. Additional circuits with additional functionality may also be included. Further, the controller 86 may further control other activity beyond the scope of the present disclosure.

As mentioned above and in one configuration, the “circuits” may be implemented in machine-readable medium for execution by various types of processors, such as processor 94 of FIG. 3. An identified circuit of executable code may, for instance, comprise one or more physical or logical blocks of computer instructions, which may, for instance, be organized as an object, procedure, or function. Nevertheless, the executables of an identified circuit need not be physically located together, but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits, and may be embodied in any suitable form and organized within any suitable type of data structure. The operational data may be collected as a single data set, or may be distributed over different locations including over different storage devices, and may exist, at least partially, merely as electronic signals on a system or network.

While the term “processor” is briefly defined above, the term “processor” and “processing circuit” are meant to be broadly interpreted. In this regard and as mentioned above, the “processor” may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

Although the diagrams herein may show a specific order and composition of method steps, the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. All such modifications are intended to be included within the scope of the present disclosure as defined in the appended claims. Such variations will depend on the machine-readable media and hardware systems chosen and on designer choice. All such variations are within the scope of the disclosure.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

Accordingly, the present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. An apparatus, comprising:
a vehicle locator circuit structured to receive GPS signal coordinates and a road parameter associated with the GPS signal coordinates, the vehicle locator circuit is further structured to identify a current road segment associated with the GPS coordinates;
a map data circuit structured to store the road parameter and GPS signal coordinates associated with the current road segment;
a route response circuit structured to determine look-ahead parameters characterizing a future road segment based on input received from the vehicle locator circuit and the map data circuit; and
a communication interface structured to communicate the look-ahead parameters to an engine control module for improving vehicle performance during travel on the future road segment.

2. The apparatus of claim 1, further comprising a route attribute circuit structured to extract road parameters associated with the future road segment.

3. The apparatus of claim 2, further comprising a protocol circuit structured to receive the extracted road parameters and communicate the road parameters to the engine control module via the communications interface.

4. The apparatus of claim 1, wherein the road parameter includes a speed limit or a road grade.

5. The apparatus of claim 1, further comprising a GPS signal lost circuit structured to determine when the vehicle locator circuit is no longer receiving a GPS signal and to communicate with the engine control module via the communications interface to no longer use the road parameter for improving vehicle performance during travel on the future road segment.

6. The apparatus of claim 1, wherein improving vehicle performance includes at least one of controlling engine operating parameters, controlling an aftertreatment system, controlling a suspension system, and controlling a braking system.

7. The apparatus of claim 1, further comprising a route learning circuit structured to store the road parameter in a local memory and use the stored road parameter to improve vehicle performance during a future trip along a learned route map.

8. The apparatus of claim 7, wherein the route learning circuit is structured to receive a start learning command and log location associated data including the road parameter over a travelled route.

9. The apparatus of claim 8, wherein the route learning circuit is structured to create a learned route map from the location associated data logged during travel over the travelled route.

10. The apparatus of claim 9, wherein the map data circuit queries the learned route map for the location associated data and provides returned road parameters to the route response circuit.

11. The apparatus of claim 1, further comprising a server learning circuit structured to communicate a learned route map to a server via the communications interface to enable other vehicles to access the learned route map.

12. The apparatus of claim 1, further comprising a server learning circuit structured to receive a learned route map from a server that was created based on location associated data acquired by another vehicle.

13. The apparatus of claim 1, further comprising a server learning circuit structured to receive a start learning command and log location associated data including the road parameter over a travelled route.

14. The apparatus of claim 13, wherein the server learning circuit is structured to create a learned route map from the location associated data logged during travel over the travelled route and to communicate the learned route map to a server via the communications interface.

15. The apparatus of claim 1, further comprising a vehicle-to-vehicle learning circuit structured to communicate a learned route map to another vehicle directly via the communications interface.

16. The apparatus of claim 15, further comprising a vehicle-to-vehicle learning circuit structured to receive a learned route map directly from another vehicle.

17. The apparatus of claim 15, further comprising a vehicle-to-vehicle learning circuit structured to receive a start learning command and log location associated data including the road parameter over a travelled route.

18. The apparatus of claim 17, wherein the vehicle-to-vehicle learning circuit is structured to create a learned route map from the location associated data logged during travel over the travelled route and to communicate the learned route map directly to another vehicle via the communications interface.

19. The apparatus of claim 1, wherein the apparatus is arranged to operate in an off-highway environment where the current road segment changes over time.

20. The apparatus of claim 1, wherein the vehicle locator circuit collects the road parameter during multiple travel events to improve the fidelity of information associated with the current road segment.
